(19) United States
(12) Patent Application Publication
(10) Pub. No.: US 2020/0139589 A1
(43) Pub. Date: May 7, 2020

(54) Mould for the Spatial Shaping of Plastic Parts made of HDPE or PA or Similar Plastics, in particular HDPE or PA Tubes

(71) Applicant: MSV Systems CZ s.r.o., Liberec (CZ)

(72) Inventors: David Tichy, Straz and Nisou (CZ); Ondrej Belohlavek, Liberec (CZ)

(21) Appl. No.: 16/278,474

(22) Filed: Feb. 18, 2019

(30) Foreign Application Priority Data
Nov. 2, 2018 (EP) 18204109.5

(51) Int. Cl. B29C 33/38; B29C 33/42

(52) U.S. Cl. CPC B29C 33/38; C08L 23/06; B29C 33/42

(57) ABSTRACT

The invention relates to a mould for the spatial shaping of plastic parts made of HDPE or PA or similar plastics, particularly HDPE or PA tubes, which comprises a body (1), which is provided with at least one contact wall (20) for contacting the mould with the shaped material. At least the contact wall (20) is made of a material with a thermal conductivity lower than 5 W·m⁻¹·K⁻¹.

### TECHNICAL FIELD

The invention relates to a mould for the spatial shaping of plastic parts made of HDPE or PA or similar plastics, in particular HDPE or PA tubes which comprises

### BACKGROUND ART

HDPE (high-density polyethylene) is a thermoplastic having a density ranging from 0.93 to 0.97 g·cm⁻³. This material is temperature resistant in the range of −50° C. to +110° C., as well as chemical resistant, odourless and suitable for direct contact with food. In addition, it is non-toxic and recyclable. Nowadays, a wide range of products—parts, including products with a complex spatial structure and shape, are made of HDPE, using plastic injection moulding technologies, foil-making technologies, blowing and extrusion technologies. The results of the manufacturing process are finished products, such as three-dimensional objects made by plastic injection moulding, foils, tubes, rods, etc. Similar is the case with PA and other plastics. As a semi-finished product for the manufacture of HDPE, PA and other plastic products, plastic is used in the form of granules, powders or tablets. Products made of these plastics, such as HDPE, PA and others, are thus made directly, obtaining the final shape at once, and secondary shaping is not generally applied. Alternatively, welding or bonding of simpler parts to form the final product can be applied. In the case of special products, such as spatially shaped tubes and other longitudinal products, etc., it is necessary to have special equipment for the production of these products, which is very costly and its operation is rather demanding.

Known are relatively simple methods for shaping plastic products from materials other than HDPE, PA, etc., such as producing complexly spatially shaped tubes from a plastic which is elastic at low temperatures by exerting force on a semi-finished product of a straight and low temperature elastic tube, whereby this semi-finished product undergoes elastic deformation and is inserted into a mould in the form of a labyrinth by which the originally straight tube is formed into the desired shape. Subsequently, the pre-shaped tube is heated by hot steam to the desired temperature either from the inside or from the outside and then is allowed to cool in the mould, whereby the originally straight tube takes on permanently the shape of the mould. The moulds used for this purpose are made either of steel or of another metal with a high temperature thermal conductivity, with steel having a thermal conductivity λ₂₀ of about 50 W·m⁻¹·K⁻¹. It is apparent that such bent tubes are made of a special elastic material which exhibits the required mechanical properties before moulding, i.e. before heating, as well as after moulding, i.e., after heating and cooling.

In the case of hot steam shaping (bending), hot steam the temperature of which is usually in the range of 110° C. to 140° C. is fed into the inner space of the shaped tube. As a result of heating the material of the shaped tube by this steam, the material of the shaped tube is brought into a plastic state in which, due to the stresses induced by inserting the shaped tube into the shaped form of the labyrinth made of steel or another metal, the originally straight tube is only elastically deformed and changes its shape, that is to say, it acquires the desired resulting and permanent shape of the bent tube. After this process of plasticizing the material of the tube, the steam supply is disconnected and the shaped tube is cooled, by which means the shape of the shaped tube is fixed in this state. If necessary, both in steam and furnace plastic tube bending, a resilient body, e.g., a spring, is inserted into the plastic tube to be bent, which ensures a circular cross-section of the plastic tube even after the tube material has been plasticized during heating and cooling. The insertion of this resilient body is not always necessary—it depends on the dimensional parameters of the bent tube, the wall thickness of the tube, the bending size, etc. In the furnace heating, after inserting the resilient body, the elastic tube is inserted into the labyrinth (bending mould), whereby by one of its ends it is inserted into the cavity of a stopper head arranged at one end of the labyrinth. The subsequent process consists in heating the shaped tube in the furnace to a plastic state, the heating temperature being in the range of 120° C. to 220° C. As a result of plasticizing the material of the shaped tube in the furnace, due to the stresses induced by inserting the shaped tube into the labyrinth, the originally straight tube is deformed into the shape of the labyrinth, whereby during the subsequent cooling, the thus formed shape of the tube being shaped is fixed. Once the shape of the shaped tube has been fixed, the inner resilient body is pulled out.

It is known that during additional shaping of semi-finished products—parts made of HDPE or PA or similar plastics, which are quite stiff under normal temperatures, this material is preheated to a temperature of a few tens of ° C., typically around 50 to 60° C., whereby the elasticity of the material slightly improves compared to the room temperature, and afterwards the material can be pushed into the mould with the application of a relatively large force and effort, for example in the case of tubes, it is necessary to literally press it into a the mould in the form of a metal labyrinth with a high thermal conductivity, which is extremely physically demanding for the operator who subsequently suffers from health problems from long-term overloading. Similarly, this is the case with attempts to automate the process of inserting the heated product into the mould, since automation results in a considerable load on the nodes of the machine, raising the need for large dimensions of these nodes, which is expensive and inefficient. Moreover, although these parts are not heated to high temperatures, it is still necessary to perform the forcing of the tube into the labyrinth manually in protective clothing against burns, which further complicates the whole process.

The drawbacks of the background art are substantially reduced by the solution according to EP application No. 18182428.5, which discloses a method and device for shaping products made of HDPE or PA, in particular the HDPE or PA tube spatial shaping, in which HDPE or PA semi-finished product is shaped such that HDPE or the PA preform is first heated to a temperature T close to the melting temperature T_{g} of the material such that the material is still in a solid state. At this temperature T the HDPE or PA semi-finished product is left for a time period t₁, which is necessary for the semi-product to obtain plasticity, to disrupt completely or partially the crystalline or semi-crystalline structure of the HDPE or PA material and to return the material to an amorphous or partially amorphous state. Thereafter, the HDPE or PA semi-finished product is inserted into a shaping fixture and the temperature of the HDPE or PA material is gradually reduced to ambient temperature in order to recover the crystalline or semi-crystalline structure and to relax the internal stresses of the HDPE or PA material, so that the shape of the shaped material after complete cooling down and removal from the mould is maintained. An ideal method for cooling the shaped part is gradual cooling by means of a tempering furnace for a certain time period at the tempering temperature required to restore or partially restore the crystalline or semi-crystalline structure and to relax the internal stresses of HDPE or PA material. Subsequently, the HDPE or PA material is freely cooled by air and, if appropriate, it is cooled with a cooling medium, whereupon the HDPE or PA material is removed from the shaping fixture as a finished product from HDPE or PA. This option is reliable but requires the use of a tempering furnace, which limits productivity and increases costs. Under certain circumstances, it is also possible that the HDPE or PA material is freely cooled by air and, if appropriate, it is cooled with a cooling medium, whereupon the HDPE or PA material must be left in the shaping fixture at normal room temperature for the time required for the shape stabilization of HDPE or PA material, and it is possible only then to remove the HDPE or PA shaped part from the shaping fixture. This variant extends the time needed to leave the workpiece in the mould, reduces productivity and increases costs.

The aim of the invention is therefore to eliminate or at least minimize the disadvantages of the background art, especially to improve productivity and also reduce the costs of the additional shaping of parts made of HDPE or PA tubes or similar plastics, particularly of HDPE or PA tubes.

### Principle of the Invention

The aim of the invention is achieved by a mould for the spatial shaping of plastic parts made of HDPE or PA or similar plastics, in particular of HDPE or PA tubes, whose principle consists in that at least the contact surface of the mould with the part to be shaped is made of a material with a thermal conductivity lower than 5 W·m⁻¹·K⁻¹.

The invention permits replacing a tempering furnace for slow cooling of the product so as to recover or partially recover the crystalline or semicrystalline structure and to relax the internal stresses of HDPE or PA material by simply cooling the product in the mould in free air and at the same time eliminating the need for leaving the product in the shaping fixture (in the mould) at normal room temperature for the time required for the shape stabilization of the HDPE or PA material, thereby achieving comparable results to using a tempering furnace even without the use of a tempering furnace. This also improves productivity by eliminating the need to wait for relaxation of internal stresses at room temperature.

### DESCRIPTION OF DRAWINGS

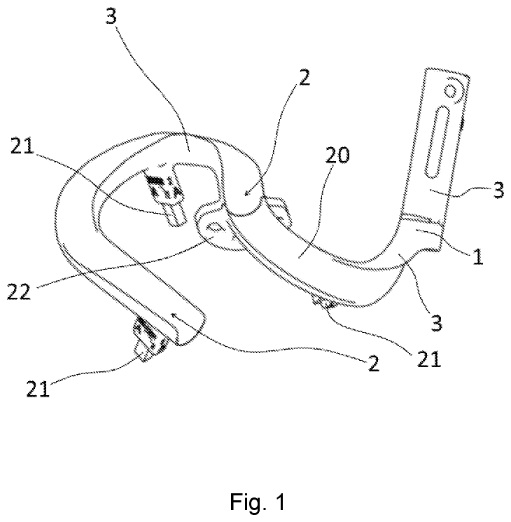

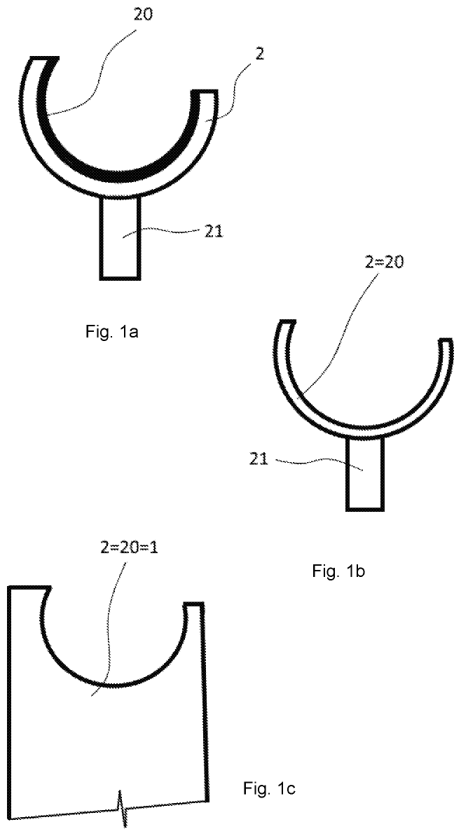

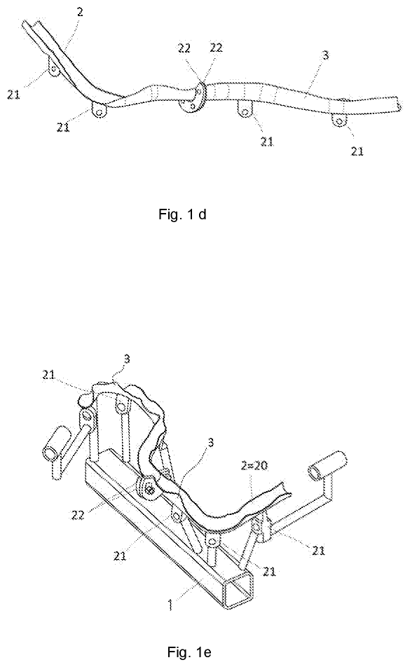

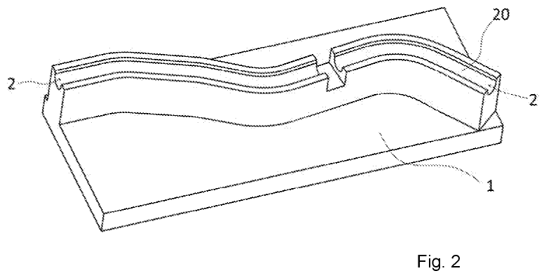

The invention is schematically represented in the drawings, wherein FIG. 1 shows an example of a labyrinth for shaping tubes made of HDPE or PA according to the invention to be fastened to a rod holder of a carrier, FIG. 1a is a sectional view of a labyrinth with a contact surface in the form of a surface layer, FIG. 1b is a sectional view of a labyrinth with a contact surface which is an integral part of the body of the labyrinth, FIG. 1c is a cross-section of a labyrinth with a contact wall which is an integral part of the body of the labyrinth which is an integral part of the carrier (see FIG. 2), FIG. 1d is an example of a labyrinth with holders for fastening to the carrier, FIG. 1e is an example of a labyrinth fastened by means of holders to the carrier and FIG. 2 is an example of a labyrinth for shaping tubes made of HDPE or PA according to the invention with an integrated carrier.

### EXAMPLES OF EMBODIMENT

The invention will be described with reference to an exemplary embodiment of a mould, or a shaping fixture, for shaping products made of HDPE or PA or similar plastics, in which a pre-prepared product, in its essence a semi-finished product, e.g., a straight tube or a multilayer tube, etc., is heated and inserted into a mould and, having been left in the mould for a required period of time, is formed into a desired shape—the resulting product, e.g. spatially shaped (bent) tubes.

The mould for the spatial shaping of plastic parts made of HDPE or PA or similar plastics comprises a body 1 in which is provided a shaping labyrinth 2. The mould 1 is created either as a single-part mould or a multi-part mould, and so is the shaping labyrinth 2. The shaping labyrinth 2 has a spatial arrangement corresponding to the desired spatial arrangement of the final product, i.e., in this case the specifically desired resulting spatial shape of the HDPE or PA tube being formed. The dimensions of the shaping labyrinth 2 correspond to the dimensions of the shaped tube. For example, the shaping labyrinth 2 is created as a spatially shaped tube with a longitudinal cavity which is provided with a through slot along its length for inserting the shaped tube into the labyrinth 2, or the shaping labyrinth 2 is created as a shaped groove in a suitable body. The shaping labyrinth 2 is made by suitable technology, for example, by cutting from a bent tube, by 3D printing, by machining, etc., or by a combination of two or more technologies, etc.

The mould is further adapted to hold the shaped tube in the shaping labyrinth 2, for example by means of flaps 3 arranged appropriately along the length of the labyrinth 2, and despite the presence of the flaps 3 the labyrinth 2 is able to accommodate the shaped tube by inserting a tube from the outside of the labyrinth 2. The shaping labyrinth 2 comprises a contact wall 20 with a shaped tube on its inner side, the contact wall 20 being a functional shaping wall 20 of the labyrinth 2, which is decisive for the future shape of the tube being formed.

In the exemplary embodiment in FIGS. 1 and 1a, the contact wall 20 of the shaping labyrinth 2 is formed by a coating or insert made of a material with a thermal conductivity lower than 5 W·m⁻¹·K⁻¹, more preferably with a thermal conductivity lower than 1 W·m⁻¹·K⁻¹, most preferably with a thermal conductivity lower than 0.5 W·m⁻¹·K⁻¹. The coating or insert is formed by a suitable technology, such as coating, 3D printing, pressing, etc., or by combining at least two different technologies.

In the exemplary embodiment in FIG. 1b, the entire shaping labyrinth 2 is made of a material with a thermal conductivity lower than 5 W·m⁻¹·K⁻¹, more preferably with a thermal conductivity lower than 1 W·m⁻¹·K⁻¹, most preferably with a thermal conductivity lower than 0.5 W·m⁻¹·K⁻¹. The labyrinth is made by a suitable technology, such as machining, 3D printing, cutting the shaped tube from a suitable material, etc., or by combining at least two different technologies.

In the embodiments of FIGS. 1, 1a, 1b, 1d and 1e, the shaping labyrinth 2 is provided with fastening means 21 for fastening it to the carrier 4, which is shown in FIG. 1e. FIGS. 1, 1a, 1b, 1d and 1e show a particularly preferred embodiment of the labyrinth 2, wherein the labyrinth 2 is for production simplification divided into sections which are provided with special flanges 22 for joining individual adjacent sections of the labyrinth 2. The embodiments of the flanges 22 and their principle, however, are not the subject-matter of the present invention.

In an exemplary embodiment of FIGS. 1c and 2, the entire mould, i.e., including the body 1 and the shaping labyrinth 2 are made of a material with a thermal conductivity lower than 5 W·m⁻¹·K⁻¹, more preferably with a thermal conductivity lower than 1 W·m⁻¹·K⁻¹, most preferably with a thermal conductivity lower than 0.5 W·m⁻¹·K⁻¹. The body 1 and the labyrinth 2 are made by a suitable technology, such as machining, 3D printing, cutting from a suitable material, etc., or by combining at least two different technologies.

An example of a material with a thermal conductivity lower than 5 W·⁻¹·K⁻¹ is wood, plastic, especially polymer, reinforced polystyrene, Teflon, a composite, especially polymeric matrix composite, etc. From the point of view of the durability of the mould, or, more specifically, of its contact wall 20, it is desirable and advantageous if the material used with a thermal conductivity lower than 5 or 1, or 0.5 W·m⁻¹·K⁻¹ has a temperature resistance at least at the level to which a shaped product of HDPE or PA or similar plastics is heated prior to being inserted into the mould according to the present invention.

The mould according to the present invention operates in such a manner that it substantially reduces heat dissipation from the shaped tube during the cooling of the tube, and therefore it is not necessary to use a tempering furnace to slow the cooling process of the product for the recovering of the crystalline or semicrystalline structure and for the relaxation of the internal tension of HDPE or PA material, nor is it necessary to prolong production time by waiting for HDPE or PA material shape stabilization in the mould in air. This results in reducing the overall cost by the acquisition cost and operating costs for the tempering furnace, shorten the production times and increase production throughput.

In the case of a mould for forming other shapes, the contact walls 20 for the contact with the material being shaped are provided with at least a coating of a material with a thermal conductivity lower than 5 W·m⁻¹·K⁻¹, more preferably with a thermal conductivity lower than 1 W·m⁻¹·K⁻¹, most preferably with a thermal conductivity lower than 0.5 W·m⁻¹·K⁻¹, or the contact walls 20 or part on which the contact walls 20 are located are directly made of a material with a thermal conductivity lower than 5 W·m⁻¹·K⁻¹, more preferably with a thermal conductivity lower than 1 W·m⁻¹·K⁻¹, most preferably with a thermal conductivity lower than 0.5 W·m⁻¹·K⁻¹.

### INDUSTRIAL APPLICABILITY

The invention is applicable for series production of products made of HDPE or PA or similar plastics by further shaping of previously produced semi-products. It is especially advantageous for the spatial shaping of HDPE or PA tubes from HDPE or PA straight tubes.

1-12: (canceled)

13. A mould for the spatial shaping of plastic tubes, comprising:
a tubular body, the tubular body further comprising an internal shaping labyrinth in a form of a spatially shaped tube defining a longitudinal cavity, the tubular body comprising an outer spatial shape corresponding to the spatially shaped tube;
the tubular body comprising an open circumference along a longitudinal length thereof that defines a longitudinally-extending through-slot such that a plastic tube to be shaped in the mould is insertable into the longitudinal cavity through the longitudinally-extending through-slot;
the internal shaping labyrinth comprising at least one contact wall disposed for contact with the plastic tube inserted into the longitudinal cavity, the contact wall formed of a material with a thermal conductivity lower than 5 W·m⁻¹·K⁻¹; and
a plurality of circumferentially-extending flaps spaced apart along the longitudinally-extending through-slot of the tubular body at locations to retain the plastic tube within the longitudinal cavity.

14. (canceled)

15. The mould according to claim 13, wherein the material has a thermal conductivity lower than 1 W·m⁻¹·K⁻¹.

16. The mould according to claim 13, wherein the material has a thermal conductivity lower than 0.5 W·m⁻¹·K⁻¹.

17. The mould according to claim 13, wherein the contact wall is made of one of: wood, plastic, composite material, Teflon, or reinforced polystyrene.

18. The mould according to claim 13, wherein the shaping labyrinth is formed entirely of the material with a thermal conductivity lower than 5 W·m⁻¹·K⁻¹.

19. The mould according to claim 18, wherein the material has a thermal conductivity lower than 1 W·m⁻¹·K⁻¹.

20. The mould according to claim 18, wherein the material has a thermal conductivity lower than 0.5 W·m⁻¹·K⁻¹.

21. The mould according to claim 13, wherein the tubular body is formed entirely of the material with a thermal conductivity lower than 5 W·m⁻¹·K⁻¹.

22. The mould according to claim 21, wherein the material has a thermal conductivity lower than 1 W·m⁻¹·K⁻¹.

23. The mould according to claim 21, wherein the material has a thermal conductivity lower than 0.5 W·m⁻¹·K⁻¹.
